(19) United States
(12) Patent Application Publication
(10) Pub. No.: US 2009/0001221 A1
(43) Pub. Date: Jan. 1, 2009

(54) SPACECRAFT GRAPPLE ASSEMBLY AND DOCKING SYSTEM EMPLOYING THE SAME

(75) Inventor: Gordon L. Collyer, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/771,597

(22) Filed: Jun. 29, 2007

(51) Int. Cl. B64G 1/64

(52) U.S. Cl. 244/172.4

(57) ABSTRACT

A spacecraft docking system configured to permit the docking of a spacecraft to a target object is provided. The docking system includes a grapple and docking interface, which is mounted on the target object. The grapple includes a body coupled to the spacecraft and at least one latching wing coupled to the body. The at least one latching wing is movable between a retracted position and an extended position, and configured to move into the extended position and latch onto the docking interface when the grapple is inserted therein.

### FIELD OF THE INVENTION

The present invention relates generally to spacecraft docking systems, and, more particularly, to a spacecraft grapple assembly that may be detachably coupled to a target object and a spacecraft docking system employing the grapple assembly.

### BACKGROUND OF THE INVENTION

Spacecraft are commonly equipped with a docking system that permits the spacecraft to be mechanically connected to an in-space object, such as a satellite, a space station, a second spacecraft, a module, and so on. The mechanical connection may permit the spacecraft's passengers to travel between the spacecraft and the object (e.g., a space station or spacecraft) or to perform maintenance on the object (e.g., a satellite or spacecraft). Docking may also enable spacecraft to exchange data and exhaustible supplies (e.g., power, water, and oxygen storages). In addition, the ability to form a mechanical connection between an appendage of the spacecraft and one or more modules (e.g., propulsion modules, habitat modules, electric power modules, storage modules, etc.) permits the assembly of in space structures.

To dock a spacecraft to a target object, the spacecraft is typically piloted to a desired location and docking procedures are commenced. In manual docking procedures, one or more passengers of the spacecraft may perform several steps to form a relatively stable connection between the spacecraft and the object. The docking systems supporting manual docking are generally complex and cumbersome, often including a retractable tunnel and a number of latching devices and seals. Automated docking systems requiring substantially less human guidance have been developed; however, such docking systems also tend to be complex and cumbersome. In addition, automated docking systems may require that the spacecraft is maneuvered to a precise location relative to the object before the docking process may commence. As a result, such processes may be relatively time consuming and, therefore, costly. Another limitation is that the automated docking system may use a semi-permanent docking means (e.g., electro-welding), which renders the undocking process more difficult. This may be especially undesirable when, for example, the docking and undocking process is continually repeated as during the assembly of a space structure.

Considering the foregoing, it should be appreciated that it is desirable to provide a spacecraft docking system that does not require precise maneuvering of a spacecraft relative to the target object and that produces a relatively stable spacecraft-to-object connection. Preferably, such a spacecraft docking system is relatively inexpensive to produce and amenable to automation. Ideally, the spacecraft docking system is scalable and utilizes a mechanical docking means that may easily and reliably disengage from the target object. Other desirable features and characteristics of the present invention will become apparent from the subsequent detailed description of the invention and the appended claims, taken in conjunction with the accompanying drawings and this background of the invention.

### BRIEF SUMMARY OF THE INVENTION

A spacecraft docking system configured to permit the docking of a spacecraft to a target object is provided. The docking system includes a grapple and docking interface, which is mounted on the target object. The grapple includes a body coupled to the spacecraft and at least one latching wing coupled to the body. The at least one latching wing is movable between a retracted position and an extended position, and configured to move into the extended position and latch onto the docking interface when the grapple is inserted therein.

A grapple assembly suitable for deploying on a spacecraft is also provided. The grapple assembly comprises a grapple, which includes: (i) an elongated body mounted through a wall of the spacecraft; and (ii) a plurality of latching wings pivotally coupled to the elongated body, which are movable between an extended position and a retracted position. The grapple also includes a latching wing retraction device, which is coupled to the body and configured to selectively move the plurality of latching wings into the retracted position. A grapple retraction device is coupled to the elongated body and configured to selectively retract the grapple such the plurality of latching wings move toward the wall of the spacecraft.

### BRIEF DESCRIPTION OF THE DRAWINGS

The present invention will hereinafter be described in conjunction with the following drawing figures, wherein like numerals denote like elements, and:

FIG. 1 is a functional schematic of a spacecraft docking system deployed on a spacecraft and on a target object in accordance with a first exemplary embodiment of the present invention;

FIG. 2 is an isometric view of an exemplary docking interface that may be mounted on a wall of the object shown in FIG. 1;

FIG. 3 is a cross-sectional view of an exemplary grapple assembly that may be deployed on the spacecraft shown in FIG. 1;

FIGS. 4-6 are functional schematics illustrating one manner in which the spacecraft of FIG. 1 may utilize the grapple assembly to dock with the target object; and

FIG. 7 is a functional schematic illustrating the ability of the spacecraft docking system shown in FIGS. 1 and 4-6 to dock despite angular misalignment between the grapple and the docking interface.

### DETAILED DESCRIPTION OF AT LEAST ONE EXEMPLARY EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

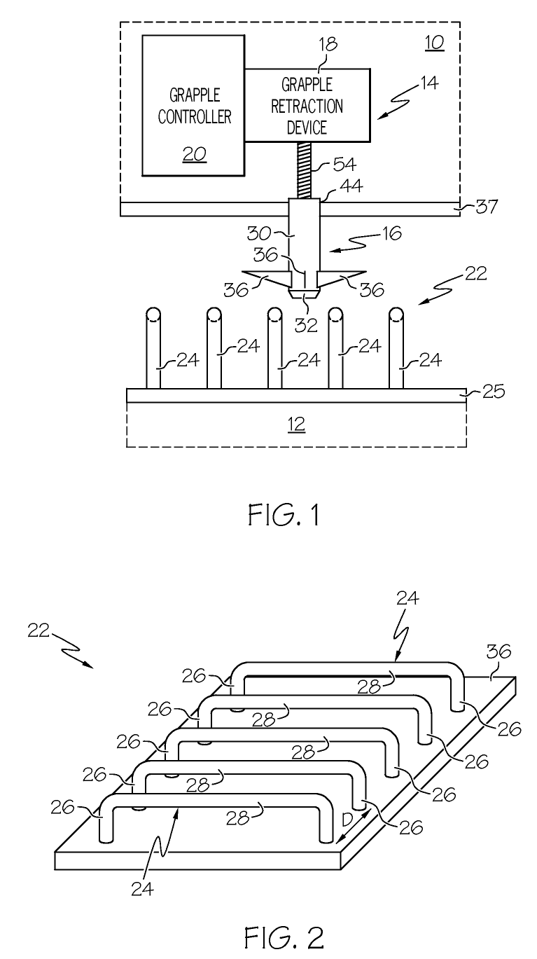

FIG. 1 is a functional schematic of a spacecraft 10 and a target object 12 (e.g., a satellite, a space station, a second spacecraft, a module, etc.). Spacecraft 10 is equipped with a grapple assembly 14, which includes a grapple 16, a grapple retraction device 18, and a grapple controller 20. Object 12 is equipped with a docking interface 22, which includes at least one structural element to which grapple 16 may be removably attached. Collectively, grapple assembly 14 and docking interface 22 form a spacecraft docking system, which enables spacecraft 10 to dock with object 12 as described in more detail below.

The docking interface may comprise any number of structures that cooperate to form a plurality of rail portions onto which grapple 16 may latch. For example, the docking interface may take the form of one or more elongated bodies having a generally helical or sinusoidal shape. FIG. 2 is an isometric view of exemplary docking interface 22, which may take the form of a lattice of cross-bars 24 projecting outwardly from a wall 25. Docking interface 22 is illustrated as including five such cross-bars 24, although any suitable number of cross-bars may be employed. Each cross-bar 24 of docking interface 22 includes first and second post portions 26, which support an elongated rail portion 28. Rail portion 28 extends between post portions 26 to form a substantially U-shaped body. In the illustrated exemplary embodiment, rail portions 28 are generally parallel; however, it should be appreciated that this need not always be the case. Post portions 26 have a predetermined height, and neighboring rail portions 28 are separated by a predetermined distance (labeled as distance D in FIG. 2). The dimensions of docking interface 22 are scalable and will vary in relation to the dimensions of grapple 16 as described discussed below. Docking interface 22 may be made of any suitable material, but is preferably formed from a lightweight metal or alloy, such as aluminum.

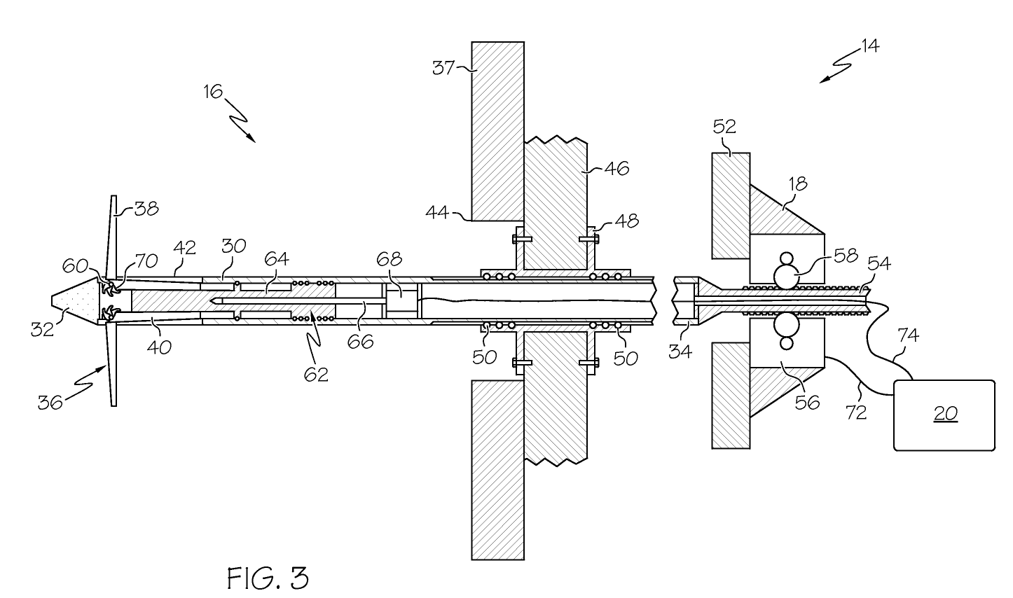

FIG. 3 is a cross-sectional view of grapple assembly 14. In this view, it can be seen that grapple 16 includes an elongated body 30 having a distal end portion 32 and a proximal end portion 34. Distal end portion 32 may include a tapered (e.g., conical) nose to facilitate the insertion of grapple 16 between rail portions 28 of cross-bars 24. One or more latching wings 36 are mounted on body 30 proximate distal end portion 32. Grapple 16 preferably includes at least three such latching wings, which may be spaced at regular intervals around the circumference of body 30. In FIGS. 1 and 3, grapple 16 is depicted as including four such latching wings 36 (only two of which may be seen in FIG. 3). Latching wings 36 are movably (e.g., pivotally) coupled to body 30 such that wings 36 may be moved between an extended position (shown at 38) and a retracted position (shown at 40). In the extended position, latching wings 36 project outwardly from body 30 to increase the outer diameter of distal end portion 32. Conversely, in the retracted position, latching wings 36 fold inwardly toward body 30 to minimize the outer diameter of end portion 32. When transitioning into the retracted position, latching wings 36 may rotate into body 30 through one or more openings 42 provided therein; however, in alternative embodiments, wings 36 may remain outside of body 30 when in their retracted position.

Wall 37 of spacecraft 10 includes an aperture 44 through which body 30 extends. To facilitate the mounting of grapple 16 through wall 37, a mounting structure 46 may be fixedly coupled (e.g., welded or soldered) thereto. In addition, a bearing assembly 48, which includes a plurality of rolling elements (e.g., ball bearings) 50, may be fixedly coupled to (e.g., bolted to) mounting structure 46 to facilitate the movement of grapple 16 with respect to wall 37.

As stated above, grapple assembly 14 includes a grapple retraction device 18, which is preferably disposed within spacecraft 10. Grapple retraction device 18 may be mounted to internal spacecraft structure 52 and coupled to distal end portion 34 of body 30 by way of a translatable shaft 54. In one option, the outer surface of shaft 54 is toothed, and grapple retraction device 18 includes at least one motor 56 having toothed gearings 58, which engage the teeth of shaft 54. Motor 56 selectively rotates toothed gearings 58, which causes toothed shaft 54, and thus grapple 16, to extend or retract with respect to wall 37 of spacecraft 10. In the illustrated exemplary embodiment, grapple retraction device 18 is equipped with two such motors 56, which engage opposite surface of shaft 54 to provide smooth operation and redundancy. This example notwithstanding, it should be appreciated that grapple retraction device 18 may assume any form suitable for extending and retracting grapple 16.

One or more biasing members may be disposed within body 30 to bias latching wings 36 toward their extended position. For example, a plurality of torsion springs 60 may be disposed around the pivot shafts of latching wings 36 and bias latching wings 36 toward their extended position. As a result, latching wings 36 will normally reside in the extended position until a force is exerted thereon sufficient to overcome the bias force supplied by torsion springs 60. This may occur as spacecraft 10 is maneuvered toward target object 12 when one or more latching wings 36 contact a cross-bar 24 of docking interface 22. Alternatively, latching wings 36 may be remotely retracted by a latching wing retraction device 62 disposed at least partially within body 30 of grapple 16. Wing retraction device 62 may include any device suitable for selectively retracting latching wings 36. In the exemplary embodiment shown in FIG. 3, retraction mechanism 62 includes a piston 64, a screw shaft 66, and a motor 68 configured to selectively rotate screw shaft 66. Piston 64 includes an internally threaded cavity, which receives screw shaft 66 therein. When motor 68 rotates screw shaft 66, piston 64 translates within body 30. In particular, piston 64 may advance toward distal end portion 32 and contact a plurality of cams 70, each of cams 70 being coupled to a different one of latching wings 36. As piston 64 continues to advance, piston 64 rotates cams 70 toward distal end portion 32, which deforms torsion springs 60 and causes latching wings 36 to rotate into their retracted position. Grapple 16 may then be withdrawn from docking interface 22 in the manner described below, and piston 64 may be retracted to allow latching wings 36 to return to their extended position under the bias force of torsion springs 60.

Grapple controller 20 is operatively coupled to grapple retraction device 18 and wing retraction device 62. For example, grapple controller 20 may be coupled to motors 56 and 68 by way of electrical connections 72 and 74, respectively. Grapple controller 20 commands motors 56 to extend or retract grapple 16 and motor 68 to retract latching wings 36 as appropriate. Grapple controller 20 may include a user input that may be manually controlled by a passenger of spacecraft 10; however, grapple controller 20 preferably includes a processor incorporated into an automated docking system. Indeed, as explained in more below in conjunction with FIG. 7, the inventive docking system significantly decreases the need for precision maneuvering of spacecraft 10 during the docking process and is consequently well-suitable for automation. Although the foregoing has described grapple controller 20 as connected to wing retraction device 62 and grapple retraction device 18 via a wired connection, it should be appreciated that any wireless communication means may also be employed.

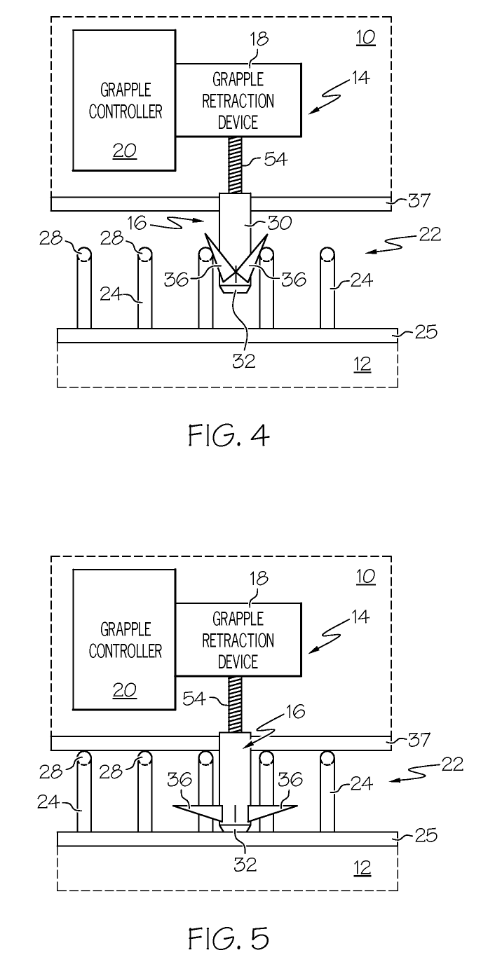

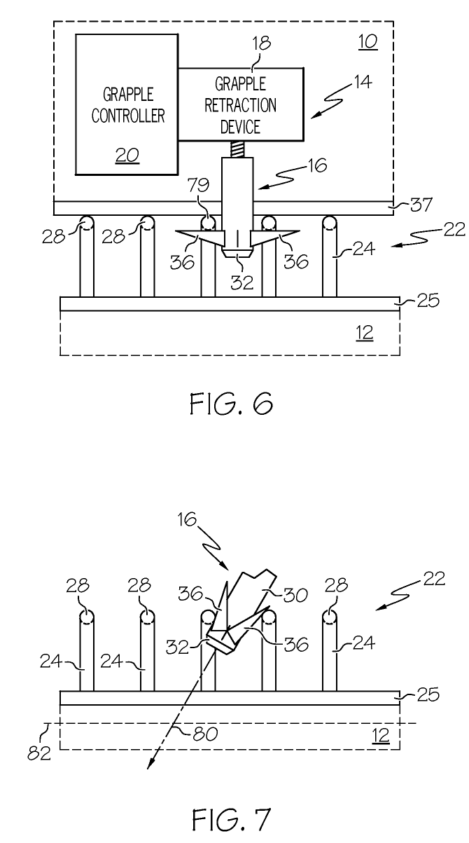

FIGS. 4-6 illustrate one manner in which grapple assembly 14 of spacecraft 10 may dock with docking interface 22 of target object 12. As shown in FIG. 4, spacecraft 10 is first maneuvered toward object 12 such that distal end portion 32 of grapple 16 passes between neighboring rail portions of cross-bars 24. As this occurs, cross-bars 24 make contact with latching wings 36 and force wings 36 into their retracted position. As spacecraft 10 continues to advance toward object 12, the tips of wings 36 move past the rail portions of cross-bars 24, and latching wings 36 are permitted to once again rotate into extended position under the influence of torsion springs 60 (FIG. 3). This results in the automatic loose capture of target object 12. Next, as shown in FIG. 6, grapple 16 is retracted toward wall 37 by grapple retraction device 18. This causes the rail portions of cross-bars 24 to be securely captured between the latching wings 36 and wall 37 of spacecraft 10 as shown in FIG. 6 at 39. Grapple retraction device 18 may be calibrated such that latching wings 36 exert sufficient force on cross-bars 24 to prevent spacecraft 10 from moving relative to object 12.

It should be noted that grapple 16 may be inserted between any two rail portions of cross-bars 24. As a result, grapple 16 may dock with nearly any portion of docking interface 22 presented to grapple 16. The geometric dimensions of docking interface 22 may be varied as desired (e.g., the number and/or length of cross-bars 28 may be increased or decreased). By providing a docking interface that is relatively large (as compared to grapple 16), the spacecraft docking system may improve system tolerances and readily accommodate positional or navigational errors that may occur during the docking process. In addition, the distal end portion 32 (i.e., the nose) of grapple 16 may be tapered as indicated in FIGS. 4-6 to facilitate the insertion of grapple 16 between cross-bars 24 and to accommodate any angular misalignment that may occur between grapple 16 and docking interface 22.

Grapple assembly 14 may readily undock from target object 12 by reversing the docking process. To commence the undocking procedure, grapple retraction device 18 first extends grapple 16 away from wall 37 of spacecraft 10 such that wings 36 move away from rail portions 28 of cross-bars 24 (FIG. 5). Next, wing retraction device 62 rotates latching wings 36 into their retracted positions. To complete the undocking process, spacecraft 10 may be maneuvered to withdraw grapple 16 from docking interface 22. If desired, the docking process may subsequently be repeated by simply disengaging wing retraction device 62 such that latching wings 36 again rotate into their extended position.

Advantageously, the above-described spacecraft docking system may be configured such that the docking process does not require the precise maneuvering of spacecraft 10 relative to target object 12. For example, docking interface 22 may be formed such that the distance between adjacent rail portions 28 is greater than the outer diameter of grapple 16 when latching wings 36 are in the retracted position, but less than the outer diameter of grapple 16 when wings 36 are in the expanded position (i.e., less than the wingspan of wings 36 in their extended position). Configuring the spacecraft docking system in the manner permits the insertion of grapple 16 between rail portions 28 of cross-bars 24 even when spacecraft 10 is not properly aligned with target object 12 (i.e., the path of travel of grapple 16 is not orthogonal to the plane of wall 37). To further illustrate this point, FIG. 7 shows docking procedure wherein grapple 16 is angularly offset from object 12. More specifically, path of travel of grapple 16 (indicated by ray 80) does not form a 90 degree angle with longitudinal axis 82 of wall 25. Despite this, the spacing between rail portions 28 and the dimensions of grapple 16 allow grapple 16 to pass between rail portions 28 thereby permitting docking to occur. Furthermore, after grapple 16 has been inserted into docking interface 22, the retraction of grapple 16 toward wall 37 will cause spacecraft 10 to properly align with object 12.

It should thus be appreciated that there has been provided a spacecraft docking system that does not require precise maneuvering of a spacecraft relative to the docking object and is consequently amenable to an automated docking procedure. The spacecraft docking system is scalable, relatively inexpensive to produce, and produces a stable spacecraft-to-object connection. Furthermore, the spacecraft docking system employs a grapple assembly that may easily and reliably be disengaged from the docking object.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A spacecraft docking system configured to permit the docking of a spacecraft to a target object, the docking system comprising:
a docking interface mounted on the target object; and
a grapple, comprising:
a body coupled to the spacecraft; and
at least one latching wing coupled to the body and movable between a retracted position and an extended position, the at least one latching wing configured to moved into the extended position and thereby latch onto the docking interface when the grapple is inserted therein.

2. A spacecraft docking system according to claim 1 wherein the at least one latching wing comprises at least three latching wings spaced substantially evenly around the circumference of the grapple body.

3. A spacecraft docking system according to claim 1 further comprising a biasing member coupled to the grapple body and biasing the at least one latching wing toward the extended position.

4. A spacecraft docking system according to claim 1 further comprising a latching wing retraction device coupled to the at least one latching wing and configured to selectively move the at least one latching wing to the retracted position.

5. A spacecraft docking system according to claim 1 further comprising a grapple retraction mechanism coupled to the grapple and configured to selectively retract the grapple toward the spacecraft.

6. A spacecraft docking system according to claim 5 wherein the grapple retraction mechanism is connected to a proximal end portion of the grapple.

7. A spacecraft docking system according to claim 1 wherein the docking interface comprises at least one structure having a plurality of rail portions.

8. A spacecraft docking system according to claim 7 wherein the plurality of rail portions are substantially parallel.

9. A spacecraft docking system according to claim 7 wherein the at least one structure comprises a lattice of cross-bars.

10. A spacecraft docking system according to claim 7 wherein neighboring ones of the plurality of rail portions are separated by a predetermined distance, the predetermined distance being greater than the outer diameter of grapple when the at least one latching wing is in the retracted position.

11. A spacecraft docking system according to claim 10 wherein the predetermined distance is less than the outer diameter of the grapple when the at least one latching wing is in the extended position.

12. A spacecraft docking system configured to permit the docking of a spacecraft to a target object, the docking system comprising:
a grapple assembly coupled to the spacecraft, comprising:
a grapple; and
a grapple retraction device coupled to the grapple and configured to selectively retract the grapple toward the spacecraft; and
a docking interface mounted on the object, the docking interface including at least first and second rail portions adapted to receive the grapple therebetween.

13. A spacecraft docking system according to claim 12 wherein the grapple comprises a plurality of latching wings pivotally coupled to the grapple and movable between an extended position and a retracted position.

14. A spacecraft docking system according to claim 13 wherein the grapple further comprises:
a latching wing retraction device coupled to the grapple and configured to selectively move the plurality of latching wings into the retracted position; and
a grapple retraction mechanism coupled to the grapple and configured to retract the grapple toward the spacecraft.

15. A spacecraft docking system according to claim 14 further comprising a grapple controller operatively coupled to the grapple retraction device and the latching wing retraction device.

16. A spacecraft docking system according to claim 14 further comprising a shaft coupled between the grapple and the grapple retraction mechanism, the shaft translatably coupled to the grapple retraction mechanism.

17. A grapple assembly suitable for deployment on a spacecraft, the grapple assembly comprising:
a grapple, comprising:
an elongated body mounted through a wall of the spacecraft;
a plurality of latching wings pivotally coupled to the elongated body and movable between an extended position and a retracted position; and
a latching wing retraction device coupled to the body and configured to selectively move the plurality of latching wings into the retracted position; and
a grapple retraction device coupled to the elongated body and configured to selectively retract the grapple such that the plurality of latching wings move toward the wall of the spacecraft.

18. A grapple assembly according to claim 17 wherein the elongated body has a distal end portion and a proximal end portion, the plurality of latching wings mounted proximate the distal end portion, and the grapple retraction device coupled to the proximal end portion.

19. A grapple assembly according to claim 17 wherein the grapple further comprises a plurality of springs each coupled to a different one of the plurality of latching wings, the plurality of spring biasing the latching wings toward the extended position.

20. A grapple assembly according to claim 18 further comprising a retractable shaft coupled between the proximal end portion and to the grapple retraction device.
